(19) United States
(12) Patent Application Publication
(10) Pub. No.: US 2012/0032432 A1
(43) Pub. Date: Feb. 9, 2012

(54) Book page adapted to favor correct reading of dyslexic individuals

(76) Inventor: Rosalba Mercanti, Perugia (PG) (IT)

(21) Appl. No.: 13/136,305

(22) Filed: Jul. 28, 2011

(30) Foreign Application Priority Data
Aug. 3, 2010 (IT) AN2010U000057

(51) Int. Cl. B42D 1/00

(52) U.S. Cl. 281/38

(57) ABSTRACT

The present invention relates to a book page provided with a mandatory layout to print words and numbers, adapted to favor reading of individuals affected by specific learning disorders, such as dyslexia.

The present patent application relates to a book page adapted to favor correct reading of dyslexic individuals.

As it is known, the term “dyslexia” is used to identify a specific learning disorder, which consists in the difficulty of reading a text fluently and, consequently, understanding its contents fully.

Although dyslexia can occur in different modes, the most typical mode is the so-called difficulty in sequential decoding.

As it is known, reading a text requires the reader to move his eyes in left-right and up-down direction; such a process is complex for all individuals that are in the initial learning stages of reading.

For individuals without specific learning disorders, however, exercise and intuition allow for overcoming such difficulties shortly, until they completely disappear.

In dyslexic individuals, instead, these difficulties tend to persist, due is to the onset of obstacles that prevent sequential decoding from being correctly executed.

In such a case some of the typical difficulties that impair the normal ability of correct and fluent reading consist in:
omission of graphemes or syllables in a word
jumps of words and jumps from one line to another in a text; for these reasons, dyslexic individuals are poorly able to follow the text to be read for the length of an entire line (even if the text is duly highlighted on the reading sheet) and go to the next paragraph correctly at the end of the line
inversion of syllables in a word
additions and repetitions of graphemes or syllables in a word.

Therefore, whereas these reading deficits are mostly generated by said incapability of dyslexic individuals to correctly follow a text, line by line, from left to right, the purpose of the present invention is to provide a reading page for dyslexic individuals with a graphic layout able to allow them to accurately follow the literal meaning of the text and correctly execute sequential decoding.

Said purpose has been achieved by providing the page of the book of the invention with a bichromatic background, being composed of a series of regularly alternating vertical bands of two different colors. Considering that said vertical bands have a constant width, each hypothetical horizontal line of a similar page has a regular alternation of spaces (or virtual boxes) distinguished by the two said colors, thus making visual division easier also for dyslexic individuals.

In practical terms, such a teaching aid must be used in such a way that the various letters of each word are printed, one by one, inside a corresponding number of said virtual boxes on the same horizontal line.

A free space, which corresponds to one of said virtual boxes, must be left between two words.

Tests have shown that a similar rational distribution of letters and words, favored by said bichromatism, allows dyslexic individuals to overcome their difficulties and read any text with sufficient fluency and accuracy.

For purposes of clarity, the description of the invention continues with reference to the enclosed drawing, which is intended for purposes of illustration only and not in a limiting sense, wherein:

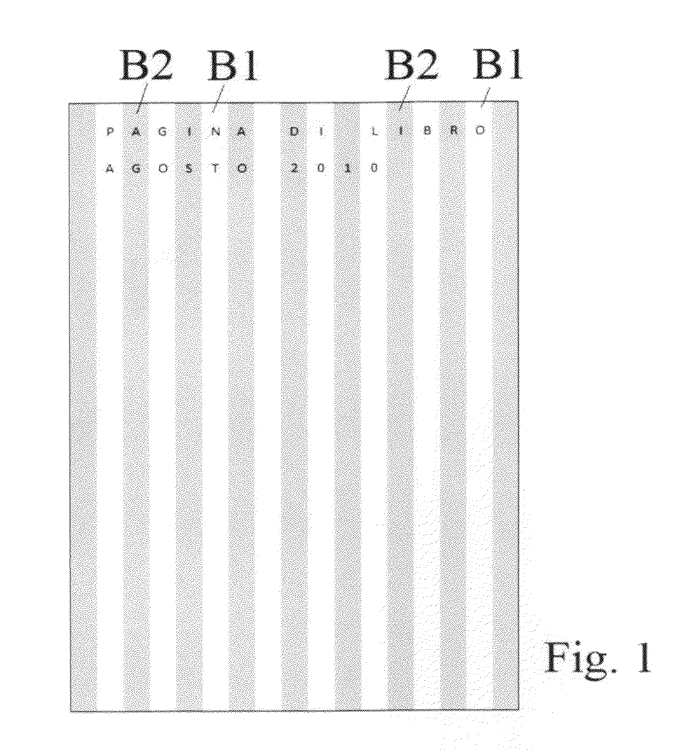

FIG. 1 is a view of a book page made according to said inventive principle that shows the specific destination of the letters of printed words;

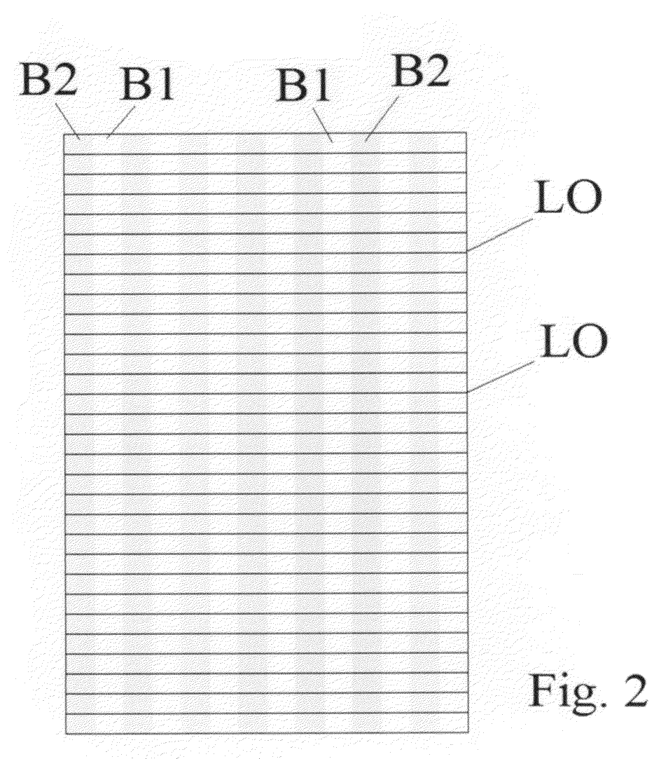

FIG. 2 is a view of an alternative embodiment of said page.

Referring to FIG. 1, the book page of the invention (1) is provided with a background formed of the regular alternation of vertical bands (B1, B2) with identical width, obtained with two different colors.

As mentioned above, the presence of the vertical bands (B1, B2) creates an alternation of virtual boxes of two different colors for each horizontal line of the page of the invention (1).

Each of these boxes is used as background to print each single letter or each single digit that composes a word or a number in sequence with other letters or digits, as shown in FIG. 1.

As shown in the same figure, the space between two words (or two numbers) must correspond to one of said virtual boxes, it being provided that in such a case the boxes are designed to remain empty.

In order to additionally implement the efficacy of the page of the invention (1)—thus favoring correct reading of dyslexic individuals—a second embodiment of the invention has been devised, as shown in FIG. 2. The peculiarity of the second embodiment of the present invention consists in the fact that said vertical bands with alternating colors (B1, B2) intersect with a regularly spaced series of horizontal lines (LO).

In addition to make said sequence of virtual boxes contained in each horizontal line more visible, each of said horizontal lines (LO) creates, line by line, the “reference plane” whereon printed letters and digits must be positioned and aligned.

As shown in the enclosed figures, the first series of vertical bands (B1) uses the background color of the page of the invention (1) and the second series of said bands (B2), which is alternated with the first series (B1), is obtained with a different light color (light grey, light blue, aqua green, etc.) that makes printed digits or letters visible.

It is understood that within the same inventive idea, an alternative color (which is different from the background color of the sheet) can be used to make the vertical bands (B1) of the first series, being provided that said color is sufficiently light and different from the one used to make the adjacent vertical bands (B2) of the second series.

Likewise, said horizontal lines (LO) can be made with a continuous line, as shown in FIG. 2, or alternatively with a broken line.

1) A book page characterized in that it is provided with a background formed of the regular alternation of vertical bands (B1, B2) with identical width, obtained with two different colors.

2) A book page as claimed in claim 1, wherein said vertical bands with alternating colors (B1, B2) are intersected by a regularly spaced series of horizontal lines (LO).

3) A book page as claimed in claim 2, wherein the spacing provided between said horizontal lines (LO) corresponds to the width of said vertical bands (B1, B2).

4) A book page as claimed in claim 2, wherein the spacing provided between said horizontal lines (LO) does not correspond to the width of said vertical bands (B1, B2).

5) A book page as claimed in claim 1, wherein said horizontal lines (LO) are obtained with a continuous or broken line.

6) A book page as claimed in claim 1, wherein the two colors used to create alternation of said vertical bands (B1, B2) are white and a different light color, in such a way to make printed digits or letters visible.

7) A book page as claimed in claim 1, wherein the two colors used to create alternation of said vertical bands (B1, B2) are two light colors other than white.
